(19) United States
(12) Patent Application Publication
(10) Pub. No.: US 2009/0118382 A1
(43) Pub. Date: May 7, 2009

(54) Ion Exchange Material, Ion Exchange Column, and Production Method

(75) Inventors: Michael Raskop, Herisau (CH); Andreas Seubert, Marburg (DE); Andreas Grimm, Frankfurt (DE)

Correspondence Address: SHOEMAKER AND MATTARE, LTD, 10 POST OFFICE ROAD - SUITE 100, SILVER SPRING, MD, 20910, US

(73) Assignee: METROHM AG, Herisau (CH)

(21) Appl. No.: 12/295,873

(22) PCT Filed: Apr. 4, 2007
(86) PCT No.: PCT/EP07/53320

§ 371 Date: Nov. 3, 2008

(30) Foreign Application Priority Data
Apr. 4, 2006 (EP) 06112215.6

(51) Int. Cl. B01J 41/14; B01J 41/12; B01J 39/20

(52) U.S. Cl. 521/32; 521/30; 521/33; 521/31

(57) ABSTRACT

The invention relates to ion-exchange materials comprising a hydrophobic support resin having grafted side chains, wherein the side chains have a surfactant-type structure and comprise ion-exchange groups, and the ion-exchange material is obtainable by radical grafting of the side chains using a radical initiator containing at least one peroxide group. By means of the surfactant-type structure and the specific radical initiator, a regiospecific and particularly uniform arrangement of the side chains on the support resin is achieved which in addition enables outstanding and uniform hydration of the ion-exchange groups. This is expressed, in particular, in improved signal asymmetries for bromide and nitrate.

The invention relates to the field of in particular particulate ion-exchange materials and also to the production thereof.

Ion-exchange materials can be constructed on a support resin which is functionalized with negatively charged groups (what are termed cation-exchange groups) or else positively charged groups (what are termed anion-exchange groups). A styrene-divinylbenzene copolymer resin is functionalized with sulfonate groups, for example, in current practice by treatment with SO₃. To these functionalized support resin particles there are fixed, via ionic interactions, ion-exchange materials which possess charges which are opposite to the functionalization of the support resin particles. For instance, in the prior art, anion-exchange materials, for example, are known which are constructed on support resin particles which are modified with (negatively charged) sulfonate groups to which anion-exchange materials having (positively charged) anion-exchange groups are fixed via ionic interaction.

In addition, surface-functionalized ion-exchange materials are known. These are obtainable by prefunctionalizing the support resin, wherein the prefunction is subsequently converted into the actual ion-exchange function.

Ion-exchange materials are currently produced using highly reactive reagents in concentrated suspensions. The ion-exchange materials which are obtainable in this manner mostly exhibit a high signal asymmetry for, e.g., slightly polarizable anions, which is disadvantageous and cannot be explained adequately.

WO 02/18464 discloses ion-exchange materials which are obtained by grafting a molecule containing an ion-exchange function onto a divinylbenzene support resin using the radical initiator 2,2′-azo-di(isobutyronitrile), AIBN. Using the method described there, an ion-exchange material is obtained which has an extremely high capacity (therefore unacceptably long retention times) with at the same time only a low number of theoretical plates.

It is therefore an object of the invention to avoid the disadvantages of the known method, in particular, therefore, to enable the provision of improved ion-exchange materials with, in particular, particulate synthetic resin support materials.

This object is achieved by an ion-exchange material and also a method for providing such an ion-exchange material according to the independent patent claims.

An ion-exchange material according to the invention comprises a hydrophobic support resin having grafted side chains which side chains comprise in particular hydrophilic ion-exchange groups, and wherein the side chains possess a surfactant-type structure.

A surfactant-type structure comprises at least one hydrophilic and one hydrophobic functional group. Hydrophilic and hydrophobic parts must in this case be matched to one another in such a manner that alignment at the interface between aqueous phase and the other (solid, liquid or gaseous) phase (here: the hydrophobic support resin) is enabled.

Surprisingly, it has been found that by means of the surfactant-type structure of the side chains, a regioselectivity and occupation density in the anchoring of these side chains on the support resin can be achieved which is superior to conventional ion-exchange materials. It was found that the surfactant-type structure enables an alignment of the side chains before grafting, which alignment is very homogeneous. The hydrophobic support resin (such as, for example, polystyrene-divinylbenzene copolymers) is wetted by the surfactant-type reagent, but not in the tightest packing. The surfactant-type molecules strive to distance themselves from one another to the extent that the electrostatic repulsion of the equally charged molecules loses its effect. This leads to a very even distribution of the surfactant-type molecules on the support material. In addition, it is found that the surfactant-type molecules scarcely penetrate into the pore structure of the support material and are scarcely anchored there. Not only by the non-utilization of the pores, but also by means of the fact that the side chains are not arranged in the tightest packing, in addition a uniform and absolutely complete hydration of the ion-exchange groups is enabled which is expressed, in particular, also in a lower signal asymmetry.

Compared with other methods known from the prior art for providing, for example, sulfonate groups, on a support resin by reaction with SO₃, graft polymerization offers the great advantage of the ready controllability of the ion-exchange capacity resulting from the degree of occupation. In graft polymerization, preferably monomers of prefabricated polymers are added by polymerization; the monomers in this case already possess the desired ion-exchange functionality, for example a sulfonate group (or a sulfonic acid salt), such that subsequent conversion after grafting is no longer necessary. By means of the grafting, a different steric environment of the exchange group is generated, compared with conventional methods for introducing ion-exchange groups, which in addition can be varied in a broad range by targeted selection of the grafting reagent, in particular in the hydrophobic part (structure, chain length, etc.).

The ion-exchange material according to the invention is obtainable by grafting by a radical mechanism of the side chains using a radical initiator containing at least one peroxide group, very particularly preferably a radical initiator based on peroxodisulfate (S₂O₈²⁻) Compared with the ion-exchange materials which are disclosed by WO 02/18464, and which can be produced using AIBN, according to the invention ion-exchange materials are obtained which, together with sufficient capacity (therefore also tolerable retention time) possess a significantly increased number of plates. Suitable representatives of the peroxide-containing radical initiators are, for example, hydrogen peroxide (H₂O₂) and also the organic peroxides dibenzoyl peroxide and di-t-butyl peroxide. Suitable inorganic peroxides are, in particular, peroxosulfuric acid (H₂SO₅), peroxosulfate (SO₅²⁻)-based radical initiators such as, for example, (NH₄)₂SO₅, Na₂SO₅ and also K₂SO₅, likewise peroxodisulfuric acid (H₂S₂O₈), peroxodisulfate (S₂O₈²⁻)-based radical initiators such as, for example, (NH₄)₂S₂O₈, Na₂S₂O₈ and also, very particularly preferably, K₂S₂O₈.

In particularly preferred embodiments the support resin comprises or consists of polymers which are selected from the group consisting of styrene-divinylbenzene copolymers; divinylbenzene-ethylvinylbenzene copolymers; divinylbenzene-acrylic acid copolymers; polyacrylates and/or polymethacrylates; amine-epichlorohydrin copolymers; graft polymers of styrene on polyethylene and/or polypropylene; poly(2-chloromethyl-1,3-butadiene); poly(vinylaromatics) resins, in particular based on styrene, alpha-methylstyrene, chlorostyrene, chloromethylstyrene, vinyltoluene, vinylnaphthalene, vinylpyridine; aminoplasts; celluloses; poly(vinyl alcohol)s, phenol-formaldehyde resins.

Particular preference is given to styrene-divinylbenzene copolymers and divinylbenzene-ethylvinylbenzene copolymers; in this case the divinylbenzene content and thereby the degree of crosslinking of the support resin can be varied in a wide range. Such support resins and production thereof are known to those skilled in the art, for example from U.S. Pat. No. 5,324,752 and EP 883 574; the description of these documents with respect to the support resins is hereby incorporated into the disclosure by reference.

Preferably, the side chain possesses a hydrophobic part having an aromatic structural unit. The ratio of the aromatic structural units present in the hydrophobic parts of the side chains to the number of the hydrophilic regions, in particular to the number of ion-exchange groups in the hydrophilic regions, is preferably ≧1, in particular ≧2, ≧3 or ≧4. A hydro-philic region in the case of a single ion-exchange group per side chain is taken to mean precisely this ion-exchange group. However, a multiplicity of ion-exchange groups can also be present in this hydrophilic region. In general, obviously, a plurality of anchoring sites on the support resin can also be present per side chain. Further preferably, the side chain comprises an aromatic structural unit which is selected from the group consisting of benzyl derivatives, naphthyl derivatives, biphenyl derivatives.

In further preferred embodiments, the side chain possesses a hydrophobic part having an in particular aliphatic hydrocarbon chain of ≧6 carbon atoms, preferably ≧8 carbon atoms, particularly preferably ≧10 carbon atoms. This aliphatic carbon chain can be provided, in particular, in addition to aromatic structural units in the side chain, or else, in particular in the case of chain lengths of ≧10 carbon atoms, can alone form the hydrophobic part of the side chain.

According to a further preferred embodiment, the support resin is formed of a polymer which possesses side chained unsaturated groups, in particular vinyl groups. Such unsaturated groups are preferably graft substrates for the side chains having the ion-exchange groups.

The grafted side chains can in this case themselves be polymers. For instance, a block (co)polymer having a vinyl function, having one or more ion-exchange groups and one or more hydrophobic regions can be used, for example. Alternatively, a polymeric side chain can also be generated with vinyl-containing surfactant-type monomers which have an ion-exchange group.

Further preferably, the support resin is particulate, at median particle diameters in the range from 2 to 100 μm, preferably 3 to 25 μm, particularly preferably 4 to 10 μm.

It has been found that using anion-exchange materials according to the invention, a signal asymmetry Aₛ can be achieved without problems for bromide and nitrate of ≦2 and/or the elution of fluoride does not proceed with the dead volume under the following conditions: 0.5-12.5 mol 1⁻¹ sodium carbonate/sodium hydrogencarbonate (in particular 1.7 mM Na₂CO₃/1.7 mM NaHCO₃, 3.0-7.5 mM Na₂CO₃, to 10.0 mM Na₂CO₃), flow rate 0.1-2.5 ml min⁻¹, temperature 293-353 K (in particular 293-313 K, preferably 303 K), column dimensions 50-250 mm length, 2.0-4.0 mm internal diameter, no eluent additions.

For a capacity of approximately 150-200 μequiv/g, typically a separation efficiency in the range of about 25 000 to about 50 000 theoretical plates per meter is achieved (eluent: 7.5 mmol/l of Na₂CO₃; flow rate: 1 ml/min; 20° C.; analytes: 10 mg/ml of fluoride, 20 mg/ml of chloride, 5 mg/ml of nitrite, 5 mg/ml of phosphate, 40 mg/ml of bromide, 20 mg/ml of sulfate, 10 mg/ml of nitrate).

As ion-exchange materials, also polymers having charged groups are known as component of the main chain, for instance, what are termed ionenes, for example. The expression ionenes is taken to mean here, and hereinafter, polymers which possess quaternary ammonium groups in the main chain. Attempts have been made in the prior art to apply such ionenes to support materials via ionic interactions in order to make them available for column chromatography. However, to date, this has only been achieved with sufficient efficiency and stability in the case of silica-based support materials (see in this context Pirogov et al., Journal of Chromatography A, 850 (1999) 53-63; Pirogov et al., Journal of Chromatography A, 884 (2000) 31-39; Pirogov et al., Journal of Chromatography A, 916 (2001) 51-59; Krokhin et al., Journal of Analytical Chemistry, 57 vol. 10 (2002) 920-927). An efficient ion-exchange material can be taken to mean such a material which possesses ≧2000 theoretical plates per column meter, preferably ≧5000, very particularly preferably ≧10 000 (in the case of anion exchangers: with isocratic elution with 1 mmol/l of Na₂CO₃/3 mmol/l of NaHCO₃ of organic and inorganic anions such as, for example, fluoride, chloride, bromide, nitrite, nitrate, phosphate, sulfate).

On account of the very advantageous properties of synthetic resin support materials (such as, for example, polystyrene-divinylbenzene copolymers) in ion chromatography, for example the mechanical and chemical stability thereof, it would be desirable to be able to fix via ionic interaction the above-described polymers having charged groups as component of the main chain or side chains, in particular the ionenes, on such synthetic resin support materials reproducibly and with sufficient resultant ion-exchange efficiency.

An ion-exchange material according to this aspect of the invention comprises a support resin having cation-exchange groups, and anion-exchange material fixed to this support resin by means of ionic interactions, wherein the anion-exchange material is a polymer having cationic groups as a component of the main chain. Particularly preferably, the cationic groups as a component of the main chain of the anion-exchange material are selected from the group consisting of ammonium groups, sulfonium groups, phosphonium groups, arsonium groups and mixtures thereof.

In particularly preferred embodiments the cationic groups comprise quaternary ammonium groups as a component of the main chain of the anion-exchange material. Such polymers having quaternary ammonium groups as a component of the main chain are frequently termed in the literature ionenes. Ionenes may be synthesized, for example, via multiple Menshutkin reaction (N-alkylation) according to the following reaction formula:

R¹R²N—(CH₂)ₙ—NR³R⁴+X—(CH₂)ₘ—X→[—N^{⊕}R¹R²—(CH₂)ₙ—N^{⊕}R³R⁴—(CH₂)ₘ—]ₓ+2X⁻

In this case R¹, R², R³, R⁴ each denote any organic moieties, wherein, in particular, short-chain, unbranched alkyl groups such as CH₃ and C₂H₅ are preferred; X denotes a leaving group, preferably a halogen. Particularly preferably, R¹, R², R³, R⁴ are all CH₃ groups. By variation of the (CH₂)ₙ or (CH₂)ₘ chains of the reactants, appropriately modified or functionalized ionenes can be obtained. Preferably, the number x of the repeat units is controlled during the polymerization in such a manner, and also the chain lengths n and m of the reactants are preferably selected such that polymers having a median molecular weight of about 2000 to about 100 000 g/mol result, preferably about 5000 to about 75 000 g/mol, particularly preferably about 8000 to about 30 000 g/mol. Polymers of this molecular weight range have proved to be particularly advantageous with respect to the efficiency and stability of the resultant ion-exchange materials.

In particularly preferred embodiments, the anion-exchange material comprises repeat units which are selected from the group consisting of:

(a)

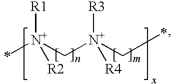

wherein independently of one another: n=2, 3, 4, 5, 6, 7, 8, 9, 10, 12, 18; m=2, 3, 4, 5, 6, 7, 8, 9, 10, 12, 18; R1=CH₃, C₂H₅; R2=CH₃, C₂H₅; R3=CH₃, C₂H₅; R4=CH₃, C₂H₅;
(b)

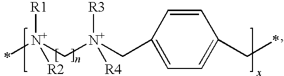

wherein independently of one another: n=2, 3, 4, 5, 6, 7, 8, 9, 10, 12, 18; R1=CH₃, C₂H₅; R2=CH₃, C₂H₅; R3=CH₃, C₂H₅; R4=CH₃, C₂H₅;
(c)

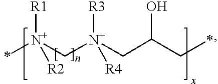

wherein independently of one another: n=2, 3, 4, 5, 6, 7, 8, 9, 10, 12, 18; R1=CH₃, C₂H₅; R2=CH₃, C₂H₅; R3=CH₃, C₂H₅; R4=CH₃, C₂H₅.

The following have proven to be particularly advantageous: 2-6 ionene (structure (a) where n=2; m=6; R1=R2=R3=R4=CH₃), preferably of a median molecular weight of about 2000 to about 100 000 g/mol, preferably of about 5000 to about 75 000 g/mol, particularly preferably of about 8000 to about 30 000 g/mol; 6-6 ionene (structure (a) where n=m=6; R1=R2=R3=R4=CH₃), preferably of a median molecular weight of about 2000 to about 100 000 g/mol, preferably of about 5000 to about 75 000 g/mol, particularly preferably of about 8000 to about 30 000 g/mol; 10-6 ionene (structure (a) where n=10; m=6; R1=R2=R3=R4=CH₃), preferably of a median molecular weight of about 2000 to about 100 000 g/mol, preferably of about 5000 to about 75 000 g/mol, particularly preferably of about 8000 to about 30 000 g/mol, and also a mixed, aliphatic-aromatic ionene of the structure (b) where n=6 and R1=R2=R3=R4=CH₃, preferably of a median molecular weight of about 2000 to about 100 000 g/mol, preferably of about 5000 to about 75 000 g/mol, particularly preferably of about 8000 to about 30 000 g/mol. The synthesis of all abovementioned ionenes is familiar to those skilled in the art.

The abovementioned support resins can in turn also be used for this aspect of the invention. Particularly preferably, the support resin is particulate at median particle diameters in the range of 2 to 100 μm, preferably 3 to 50 μm, particularly preferably 4 to 25 μm.

According to further preferred embodiments, the support resin comprises cation-exchange groups which are selected from the group consisting of sulfonate groups, carboxyl groups, chelating agents and mixtures thereof. Very particularly preferably, the support resin comprises sulfonate groups.

According to a further preferred embodiment, the cation-exchange capacity of the support resin is set by the abovementioned cation-exchange groups to 1-250 μequiv/g, preferably 3-70 μequiv/g, particularly preferably 5-50 μequiv/g. The cation-exchange capacity of the support resin is of great importance for the possibility of being able to fix the anion-exchange material thereon: at a cation-exchange capacity which is too low, the anion-exchange material (which is of the opposite charge) cannot be fixed, whereas, although, at an excessive cation exchange capacity, the anion-exchange material can be fixed, the charges of the anion-exchange material are (over)compensated for and therefore anion-exchange activity no longer results. The cation-exchange capacity must therefore be carefully controlled, and preferably also further matched to the respective polymeric anion-exchange material to be used having cationic groups as component of the main chain. Using methods of sulfonation, for example with SO₃, such a control of the cation-exchange capacity succeeds only with difficulty. The production of ion-exchange materials according to the invention, however, succeeds simply and outstandingly reproducibly using the method described hereinafter.

A further aspect of the invention relates to a method for producing an ion-exchange material, comprising the steps:

providing a hydrophobic support resin;

grafting by a radical mechanism of a grafting reagent having surfactant-type structure onto the support resin, wherein the grafting reagent comprises at least one in particular hydrophilic ion-exchange group, and wherein the radical initiator used is a radical initiator containing at least one peroxide group, in particular selected from the group consisting of hydrogen peroxide; dibenzoyl peroxide; di-t-butyl peroxide; peroxosulfuric acid; peroxosulfate-based radical initiators, in particular (NH₄)₂SO₅, Na₂SO₅ and also K₂SO₅; peroxodisulfuric acid; peroxodisulfate-based radical initiators, in particular (NH₄)₂S₂O₈, Na₂S₂O₈ and also, very particularly preferably, K₂S₂O₈.

The grafting reaction as such is familiar to those skilled in the art; the radical initiator is added in amounts which are conventional in the art. It has been found that it is particularly advantageous if the grafting reagent is purified before it is grafted to the support resin. The grafting reagents can be obtained, for example, by nucleophilic substitution of vinylbenzyl halide, in particular vinylbenzyl chloride, with an amine. The vinylbenzyl chloride in this case is preferably used in a form stabilized using an inhibitor (not only for reasons of cost but also to suppress unwanted autopolymerization). The inhibitor and also solvents and byproducts, however, can adversely affect the graft reaction in step (b). For instance it has been found that a particularly uniform occupation density of the support resin—and therefore uniform hydration of the ion-exchange groups—is achieved when the grafting reagent is purified before grafting. In most cases this can proceed, for example by precipitation with acetone and subsequent washing with organic solvents.

As described hereinabove, it is preferred that the grafting reagent possesses a hydrophobic part having an aromatic structural unit. Instead, or in addition, the grafting reagent can possess a hydrophobic part having an in particular aliphatic carbon chain of ≧6 carbon atoms, preferably ≧8 carbon atoms, particularly preferably ≧10 carbon atoms.

As support resins, suitable polymers are, in particular, the polymers which are mentioned hereinabove and which possess, in particular, side chained unsaturated groups, in particular vinyl groups.

The grafting reaction can be carried out as graft-block (co)polymerization (grafting a polymeric side chain) or as graft-(co)polymerization (polymer formation of the side chain from monomers).

It is further preferred that the grafting reagent comprises a vinyl function, in particular a structural unit which is selected from the group consisting of vinylbenzyl derivatives (in particular a salt, preferably the sodium salt of a vinylbenzenesulfonic acid, in particular of 4-vinylbenzenesulfonic acid); condensed vinylaromatics, in particular vinylnaphthyl derivatives; non-condensed vinylpolyaromatics, in particular vinylbiphenyl derivatives. In addition, preference is given to grafting reagents which bear quaternary ammonium groups as ion-exchange groups; particular preference is given to those having a diethanol/methylammonium group.

The grafting reagent is preferably selected from the group consisting of:
(a) vinylbenzyl derivatives according to the general formula:

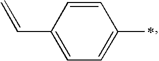

wherein (*) denotes an ion-exchange group bound directly or via an in particular aliphatic linker;

in particular

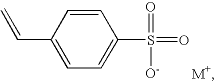

wherein M⁺ denotes an alkali metal cation, preferably Na⁺; and/or

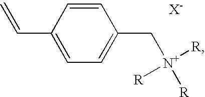

wherein X⁻ denotes a halide, preferably Cl⁻, and wherein (R) in each case independently of one another denotes a preferably at least partly aliphatic side chain, in particular —CH₂—R′ (where R′=H or any aliphatic and/or aromatic moiety), preferably —CH₃, —(CH₂)ₙCH₃ (where n=1 to 7), —CH₂(CH₂)ₙOH (where n=0 to 7), —CH₂═CH₂, —(CH₂)ₙ-aromatic (where n=1 to 7);
(b) condensed vinylaromatics, in particular according to the general formula

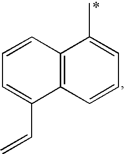

wherein (*) denotes an ion-exchange group bound directly or via a linker;
(c) non-condensed bi- or polyaromatics having at least one vinyl function and having at least one ion-exchange group, in particular according to the general formula

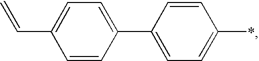

wherein (*) denotes an ion-exchange group bound directly or via a linker;
(d) di- or polyvinyl compounds, in particular di- or polyvinylaromatics, in each case bridged with a quaternary amine function,

in particular according to the general formulae

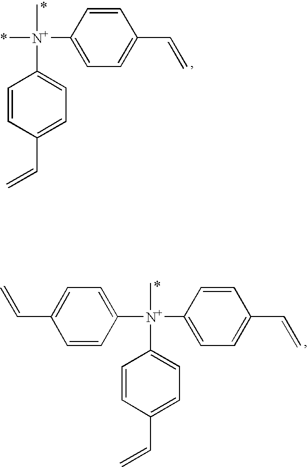

wherein (*) denotes an ion-exchange group bound directly or via a linker; or

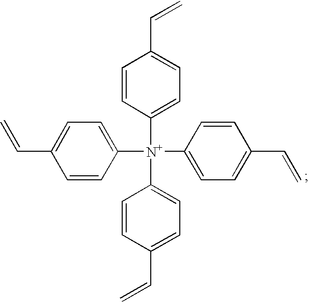

(e) di- or polyvinyl compounds, in particular di- or polyvinylaromatics, in each case bridged via more than one quaternary amine function,

in particular according to the general formulae

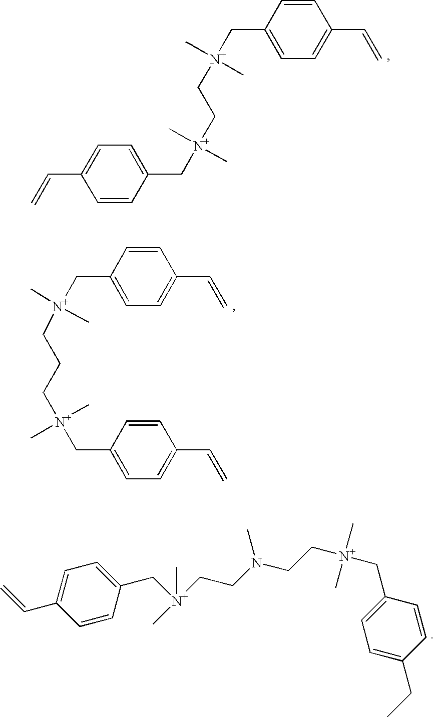

Preferred grafting reagents ((§) here denotes in each case a vinyl-containing organic moiety, preferably the vinyl group itself) are, in particular:

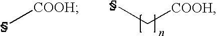

in particular where n=1-4;

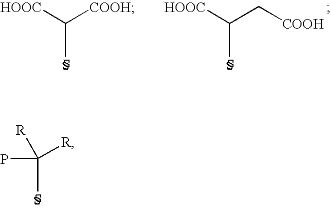

wherein R in each case independently of one another is an organic moiety, in particular where R═H, CH₂CH₃, CH₃, COOH, CH₂COOH, CH₂CH₃COOH, vinyl, hexyl, phenyl;

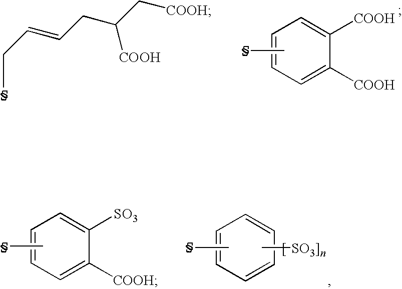

where n=1-3;

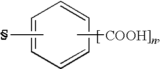

where n=1-3;

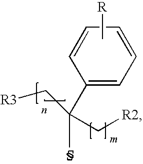

in each case independently of one another where R═SO₃, COOH, and R2, R3=H, CH₂CH₃, CH₃, COOH, CH₂COOH, CH₂CH₃COOH, vinyl, hexyl, phenyl, and n, m=2-16;

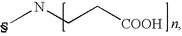

where n=1-3;

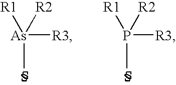

in each case independently of one another having R1, R2, R3═SO₃, COOH, H, CH₂CH₃, CH₃, CH₂COOH, CH₂CH₃COOH, vinyl, hexyl, phenyl;

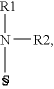

in each case independently of one another having R1, R2, R3═SO₃, COOH, H, CH₂CH₃, CH₃, CH₂COOH, CH₂CH₃COOH, vinyl, hexyl, phenyl;

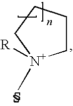

having R═SO₃, COOH, H, CH₂CH₃, CH₃, CH₂COOH, CH₂CH₃COOH, vinyl, hexyl, phenyl, and n=1-5;

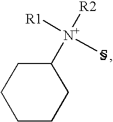

in each case independently of one another having R1, R2═SO₃, COOH, H, CH₂CH₃, CH₃, CH₂COOH, CH₂CH₃COOH, vinyl, hexyl, phenyl;

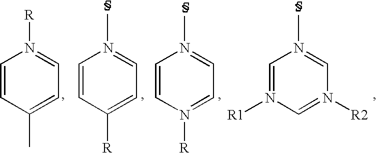

in each case independently of one another having R, R1, R2═SO₃, COOH, H, CH₂CH₃, CH₂COOH, CH₂CH₃COOH, vinyl, hexyl, phenyl;

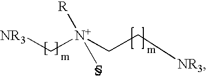

in each case independently of one another having SO₃, COOH, H, CH₂CH₃, CH₃, CH₂COOH, CH₂CH₃COOH, vinyl, hexyl, phenyl, and in each case independently of one another n, m=1-17;

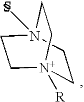

having R═SO₃, COOH, H, CH₂CH₃, CH₃, CH₂COOH, CH₂CH₃COOH, vinyl, hexyl, phenyl;

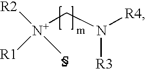

in each case independently of one another having R1, R2, R3, R4═SO₃, COOH, H, CH₂CH₃, CH₃, CH₂COOH, CH₂CH₃COOH, vinyl, hexyl, phenyl, and m=1-17;

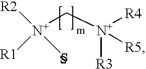

in each case independently of one another having R1, R2, R3, R4, R5═SO₃, COOH, H, CH₂CH₃, CH₃, CH₂COOH, CH₂CH₃COOH, vinyl, hexyl, phenyl, and m=1-17.

Preference is given, in addition, to surfactant-type grafting reagents containing pyrrolidine, piperidine, morpholine, pyrrole, pyridine, pyrimidine, pyrazine, triazine, pyridone, quinoline, purine, indole, oxazole, thiazole, imidazole ring systems and also combinations of such ring systems.

An ion exchanger in the context of the present invention is, in particular, not taken to mean: 2-hydroxyethyl methacrylate; N-vinylpyrrolidone; N-vinylcaprolactam.

From the aspect of ionic fixing of ionenes to a support resin, the method comprises the steps:
(a) functionalizing a hydrophobic support resin with cation-exchange groups by means of graft polymerization;
(b) fixing a polymeric anion-exchange material having cationic groups as a component of the main chain to the support resin via ionic interactions.

Particularly preferably, the cationic groups, as component of the main chain of the anion-exchange material, comprise quaternary ammonium groups, sulfonium groups, phosphonium groups, arsonium groups and, if appropriate, mixtures thereof.

It is further preferred that the support resin is functionalized with at least one grafting reagent which contains at least one vinyl group and which further contains a functionality which is selected from the group consisting of sulfonate groups, carboxyl groups, chelating agents and mixtures thereof.

The graft polymerization is preferably controlled in such a manner that an ion-exchange capacity, in particular a cation-exchange capacity, of the functionalized support resin of 1-250 μequiv/g is achieved.

In further particularly preferred embodiments, the support resin is functionalized with at least one grafting reagent which contains at least one vinyl group and which further contains a functionality which is selected from the group consisting of sulfonate groups, carboxyl groups, chelating agents and mixtures thereof.

For the subsequent possibility of fixing the ionene via ionic interactions, it has proved to be particularly advantageous when the graft polymerization is controlled in such a manner that a cation-exchange capacity, of the functionalized support resin of 1-150 μequiv/g is achieved, preferably 3-70 μequiv/g, particularly preferably 5-50 μequiv/g. At such cation-exchange capacities, sufficient charges are available for fixing the ionenes, but the charges of the ionenes are not (over)compensated for.

The invention will be described hereinafter for better understanding on the basis of illustrative examples and figures without the invention being restricted to these embodiments. In the figures:

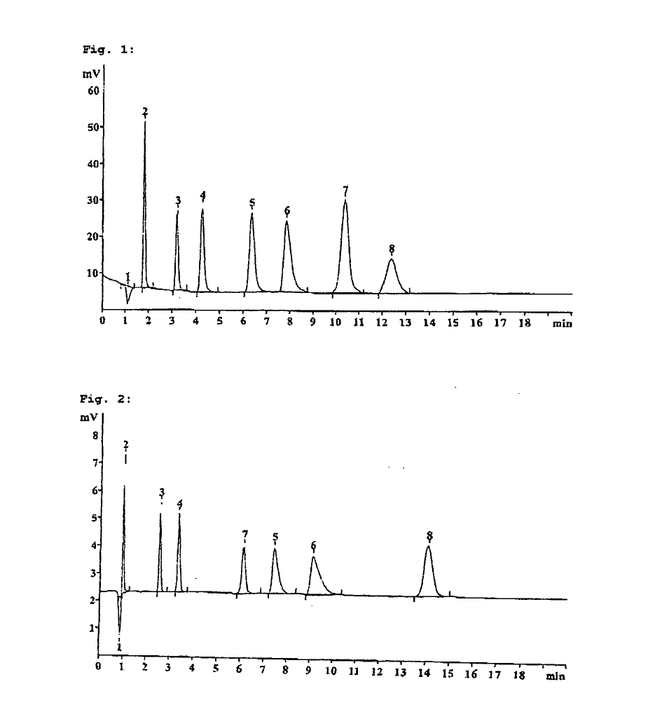

FIG. 1 shows an elution profile of an anion-exchange material according to the invention;

FIG. 2 shows an elution profile of the commercial anion exchanger A SUPP 10-100, Metrohm AG; in comparison to FIG. 1;

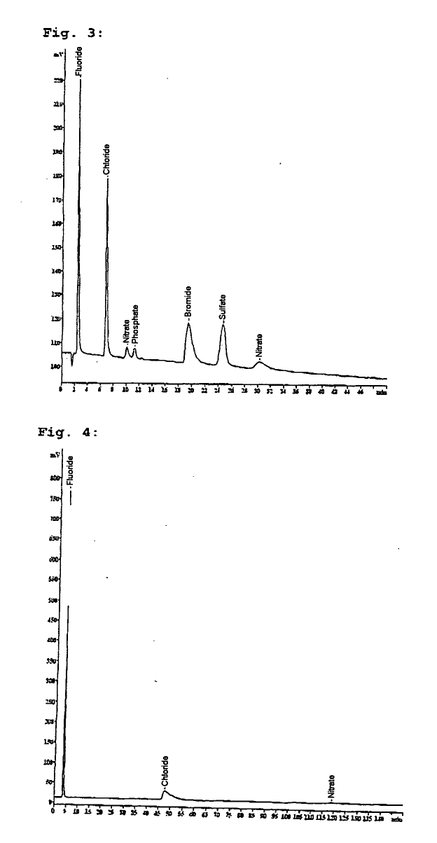

FIG. 3 shows an elution profile of an anion-exchange material according to the invention (radical initiator: K2S208);

FIG. 4 shows an elution profile of an anion-exchange material using AIBN as radical initiator;

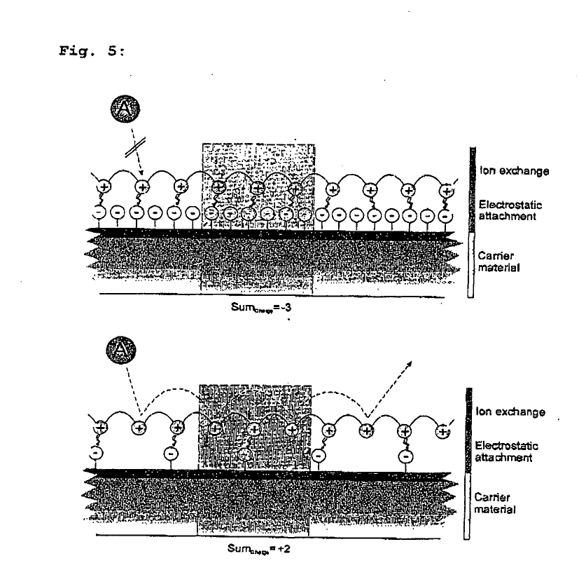

FIG. 5 shows an illustration of fixing ionenes to support resins;

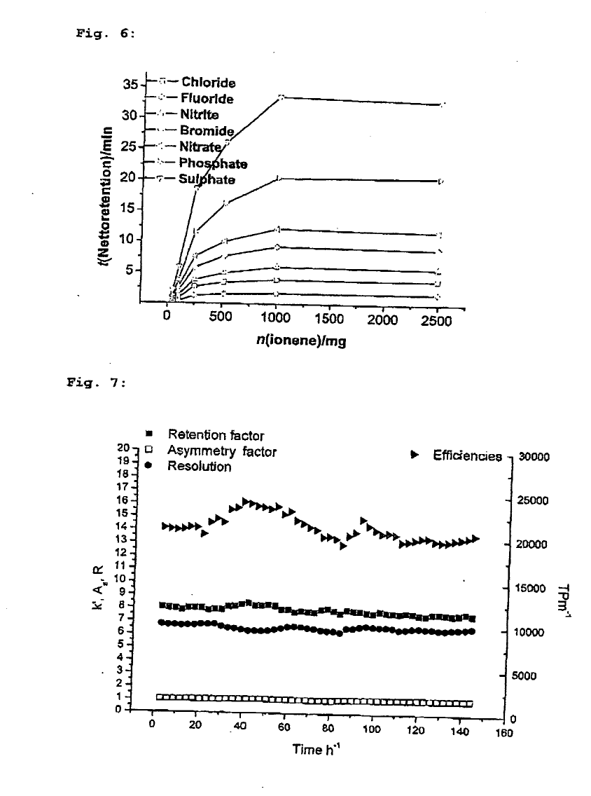

FIG. 6 shows net retention of various anions as a function of the amount of the ionene fixed to the support resin (for example of 6-6-ionene on PS/DVB, sulfonate-functionalized by means of graft polymerization);

FIG. 7 shows long-term stability of an ion-exchange column according to the invention (for example of 6-6-ionene on PS/DVBB, sulfonate-functionalized by means of graft polymerization and a cation exchange capacity of 20 μequiv/g).

### SYNTHESIS OF N-DIVINYLBENZYL-N,N-DIETHANOLMETHYL-AMMONIUM CHLORIDE (FSDEMA)

5.00 ml (0.035 mol) of stabilized vinylbenzyl chloride in 15.0 ml of dichloromethane are charged into a dry 100 ml three-necked flask equipped with a reflux cooler and protective gas connection and flushed with nitrogen with stirring. By means of a septum, 10.00 ml (0.087 mol) of diethanol/methylamine are added dropwise in the course of 1 hour. As a result of further addition of 40.0 ml of acetone, after 2 hours a white solid forms in the yellow solution. Subsequently the mixture is stirred for 3 hours at room temperature and the solid is filtered off. This is washed repeatedly with acetone. The resultant crystalline white solid (FSDEMA) is dried in high vacuum.

¹H-NMR (D₂O, ppm): 2.9 (s, 3H), 3.3-3.6 (m, 4H), 4.0-4.1 (m, 4H), 4.5 (s, 2H), 5.3 (d, 1H), 5.8 (d, 1H), 6.8 (q, 1H), 7.4-7.7 (m, 4H).

Production of a Support Material Functionalized with FSDEMA

7.50 g of dried support material (high crosslinked, non-functionalized PS/DVB particles having a mean particle size of approximately 4600 nm, with 20-80% DVB) were placed into the dry reactor. This was stirred dry until relatively large agglomerates were no longer present. Subsequently, 80.0 ml of H₂O and 20.0 ml of ethanol are placed into the reactor and the suspension was heated to 343 K, with stirring, under nitrogen as protective gas. After the reaction temperature is reached, 1.20 g of FSDEMA is added as solid and the mixture is stirred for 5 minutes. Thereafter, 1.20 g of potassium peroxodisulfate is added as radical initiator. This serves at the same time as the starting point of the reaction. The suspension is stirred over the reaction time of 4 hours at 343 K under protective gas. Subsequently, the suspension is cooled to 278 k and the solid is filtered off and washed with ethanol. The resultant product is sedimented for 24 hours in 200 ml of sedimentation solution (175 ml of ethanol and 25 ml of cyclohexanol). The supernatant solution is removed, the solid is again washed with ethanol and dried.

FIG. 1 shows as an example an elution profile of this anion exchanger (1-dead volume; 2-fluoride; 3-chloride; 4-nitrite; 5-bromide; 6-nitrate; 7-phosphate; 8-sulfate) under the following elution conditions: column temperature 318 K; eluent: 7.5 mmol/l of sodium carbonate; flow rate: 1.0 ml/min; column dimension: 100×4 mm.

In comparison therewith, FIG. 2 shows as an example an elution profile of a high-performance commercial anion exchanger (A SUPP 10-100 (serial number 040907-S42), Metrohm AG) with identical peak assignment as in FIG. 1, under the following elution conditions: column temperature 318 K; eluent: 5.0 mmol/l of sodium carbonate, 5.0 mmol/l of sodium hydrogencarbonate; flow rate: 1.2 ml/min.

In the comparison of the elution profiles, critical differences may be seen:
Whereas in the anion exchanger according to the invention the fluoride is not eluted with the dead volume, the fluoride in the case of the commercial anion exchanger elutes with the dead volume, is therefore not resolved. This indicates a comparatively lower occupation density in the anion exchanger according to the invention.
The peak asymmetry Aₛ of bromide and nitrate is significantly lower in the anion exchanger according to the invention than in the commercial anion exchanger, which indicates a uniform hydration of the anion-exchange groups, therefore also a uniform distribution of the side chains on the support resin.

FIG. 1: Aₛ (Br⁻)=1.53
Aₛ (NO₃⁻)=1.96

FIG. 2: Aₛ (Br⁻)=2.43
Aₛ (NO₃⁻)=3.42

FIG. 3 shows an elution profile of an ion-exchange column according to the invention (radical initiator K₂S₂O₈; production method as described above for FSDMA functionalization, but here using vinylbenzyltrimethylammonium chloride) in a comparison with the elution profile of an ion-exchange column according to

WO 02/18464, example 11 (FIG. 4, radical initiator AIBN, likewise with vinylbenzyltrimethylammonium chloride).

Two syntheses of each were carried out, from which in each case three columns (100×4 mm) were produced. The following result has mean values per synthesis (n.d.: not determined):

TABLE 1
(for FIG. 3, according to the invention):

| | Fluoride | Chloride | Nitrite | Phosphate | Bromide | Sulfate | Nitrate |
|---|---|---|---|---|---|---|---|
| Gross | 2.43 | 7.04 | 9.87 | 11.57 | 20.73 | 25.84 | 32.57 |
| retention | | | | | | | |
| (min) | | | | | | | |
| Separation | 15701 | 29330 | 23927 | 32888 | 17327 | 34896 | 17346 |
| efficiency | | | | | | | |
| (TP/m) | | | | | | | |
| Asymmetry | 2.27 | 1.64 | 1.53 | 1.27 | 2.14 | 1.32 | 2.01 |

Capacity: 175 μequiv/g

TABLE 2
(for FIG. 4, according to WO 02/18464):

| | Fluoride | Chloride | Nitrite | Phosphate | Bromide | Sulfate | Nitrate |
|---|---|---|---|---|---|---|---|
| Gross | 3.68 | 44.92 | 111.79 | n.d. | n.d. | n.d. | n.d. |
| retention | | | | | | | |
| (min) | | | | | | | |
| Separation | 15492 | 6350 | 4308 | n.d. | n.d. | n.d. | n.d. |
| efficiency | | | | | | | |
| (TP/m) | | | | | | | |
| Asymmetry | 1.17 | 4.32 | 4.51 | n.d. | n.d. | n.d. | n.d. |

Capacity: 385 μequiv/g

It can be seen from FIGS. 3 and 4 and also tables 1 and 2 hereinbefore that ion-exchange columns according to the invention, with the use of a peroxodisulfate (S₂O₈²⁻)-based radical initiator (FIG. 3), compared with the previously known ion-exchange columns (FIG. 4), for a higher separation efficiency (theoretical number of plates per meter, TP/m) and in part significantly improved asymmetry, also possess retention times which are still acceptable. Owing to the extremely high capacity, in the case of previously known ion-exchange columns according to FIG. 4 and table 2 hereinbefore, extremely long gross retention times result, which is undesirable.

FIG. 5 shows by way of illustration the electrostatic fixing of ionenes to support resins functionalized with cation-exchange groups.

The upper part shows an excessive degree of functionalization of the support resin: although the ionene is fixed, a net negative charge results, as a result of which anion-exchange capacity is not provided (completely sulfonated commercially available PS/DVB support resins possess a cation-exchange capacity of approximately 2000 μequiv/g, which would completely overcompensate for the charges of ionenes).

The lower part illustrates a sufficient, but low, degree of functionalization of the support resin which, after the ionene has been fixed, results in a net positive charge, as a result of which an ion-exchange capacity is provided. By means of the method according to the invention, a defined suitable degree of functionalization can particularly readily be set.

### Production of the Ionenes

Where not stated otherwise, here and hereinafter chemicals of “spectral grade” purity or better must be used. The ionenes are obtained by multiple Menshutkin reaction. 50 mmol of an organic diamine (e.g. N,N,N,N′-tetramethyl-1,6-hexanediamine; Fluka, Buchs, Switzerland) are placed into 25 ml of DMF and 50 mmol of organic dihalide (e.g. 1,6-dibromohexane; Merck, Hohenbrunn, Germany) in 25 ml of DMF are slowly added with stirring. Depending on the reactivity of the monomers, the reaction is allowed to proceed further for a period between 15 h and 120 h. The reaction mixture is poured into a large excess of acetone and the precipitate is filtered off and dried under reduced pressure. High-grade hygroscopic products are obtained.

### Functionalization of the Support Resin (Graft Polymerization)

(By way of example based on 4-vinylbenzenesulfonic acid sodium salt on PS/DVB) 2 g of dried polystyrene/divinylbenzene support material of 5 μm mean size are placed into a dry reactor. The material is stirred dry until relatively large agglomerates are no longer visible. 80 g of deionized water and 15.8 g of ethanol are placed into the reactor and subsequently heated to 70° C. under a protective nitrogen atmosphere. Subsequently, for different reaction batches, various amounts of 4-vinylbenzenesulfonic acid sodium salt are added. Thereafter, 0.5 g of potassium peroxodisulfate are added. The mixture is allowed to react under the protective gas atmosphere for 4 h at 70° C. Subsequently the suspension is cooled to 5° C. and the solid is filtered off and washed with 100 ml of ethanol. The resultant product in 200 ml of sedimentation solution (175 ml of ethanol and 25 ml of cyclohexanol) is sedimented for 24 h. The supernatant solution is removed, the remaining solid is again washed with 200 ml of ethanol and dried under reduced pressure.

The resultant cation-exchange capacity (proton-exchange capacity) of the support material may be readily and reproducibly controlled via the amount of 4-vinylbenzenesulfonic acid sodium salt added: for instance for an addition of 0.025 g of 4-vinylbenzenesulfonic acid sodium salt, 5 μequiv/g are obtained, at 0.050 g 10 μequiv/g, at 0.075 g 15 μequiv/g, at 0.150 g 30 μequiv/g, at 0.225 g 45 μequiv/g, at 0.350 g 70 μequiv/g, and at 0.425 g 85 μequiv/g.

### Fixing the Ionenes to the Support Resin and Column Production

Solutions of 0.500 g of the respective ionene in 5.0 ml of deionized water are added with stirring to a suspension of 2.0 g of the respective functionalized support resin in 45.0 ml of deionized water. The mixture is stirred at 70° C. for 30 minutes. A suspension is obtained of an ion-exchange material which is further processed in this form. It has been found that when the ionenes are fixed to the support resin, an excess of the ionene can be added without problem: on saturation of the support resin with ionene, neither a further increase in capacity nor a change in selectivity is observed (cf. FIG. 6).

Columns are produced with the various ion-exchange materials obtained according to methods familiar to those skilled in the art using conventional column packing devices.

The following ion-exchange columns were obtained with the various functionalized support resins and various ionenes (na=not available):

TABLE 3

| | Anion | Anion | Anion |
|---|---|---|---|
| Cation | exchange | exchange | exchange |
| exchange | capacity of | capacity of | capacity of |
| capacity of | the 2-6- | the 6-6- | the 6-10- |
| the support | ionene | ionene | ionene |
| resin | column | column | column |
| [μequiv/g] | [μequiv/g] | [μequiv/g] | [μequiv/g] |
| 5 | <5 | 34 | 165 |
| 10 | 7 | 21 | 147 |
| 15 | 11 | 28 | 142 |
| 30 | 24 | 33 | 152 |
| 45 | na | 29 | na |
| 70 | na | 31 | na |
| 85 | na | 33 | na |

### Performance Profile of the Columns Containing the Ion-Exchange Materials According to the Invention

The table hereinafter shows, for the example of 6-6 ionene, fixed under saturation to a PS/DVB support resin having a cation exchange capacity of 30 μequiv/g (produced as described hereinbefore) the typical outstanding performance characteristics of an ion-exchange material according to the invention or of an ion-exchange column according to the invention (RSD=relative standard deviation; TP/m=number of theoretical plates per column meter).

TABLE 4

| | Retention | | Asymmetry | | Resolution | | | |
|---|---|---|---|---|---|---|---|---|
| | factor k | | factor Aₛ | | R | | Efficiency | |
| | Ø | RSD | | RSD | | RSD | Ø | RSD |
| | [min⁻¹] | [%] | Ø | [%] | Ø | [%] | [TPm⁻¹] | [%] |
| Fluoride | 1.13 | 2.08 | 2.23 | 1.68 | 3.92 | 6.58 | 6715 | 4.05 |
| Chloride | 2.76 | 2.16 | 1.02 | 12.77 | 2.56 | 6.77 | 11264 | 22.16 |
| Nitrite | 3.84 | 2.18 | 1.20 | 3.41 | 4.27 | 4.42 | 15039 | 9.46 |
| Bromide | 6.02 | 2.64 | 1.08 | 3.38 | 2.81 | 2.46 | 18897 | 6.86 |
| Nitrate | 7.88 | 2.68 | 1.06 | 2.47 | 6.56 | 2.17 | 20037 | 6.70 |
| Phosphate | 14.15 | 2.81 | 0.93 | 3.25 | 2.70 | 1.48 | 20249 | 10.75 |
| Sulfate | 22.87 | 3.22 | 0.93 | 3.09 | 0.00 | 0.00 | 19169 | 14.03 |

All columns produced according to the invention are also outstandingly robust and stable in the long term (FIG. 5): neither retention factor, nor asymmetry factor, resolution or efficiency are significantly affected during long-term experiments; FIG. 7 shows this for the example of 6-6 ionene on 20 μequiv/g PS/DVB support material, produced as described hereinbefore. The test anion used was phosphate, under standard chromatography conditions (eluent: 1 mmol/l of Na₂CO₃, 3 mmol/l of NaHCO₃; flow rate: 0.8 ml/min; temperature: 30° C.). Not even the passage of 100 mmol/l of NaOH for one day led to a significant change in retention factors or efficiency (data not shown).

1-30. (canceled)

31. An ion-exchange material comprising a hydrophobic support resin having grafted side chains, wherein the side chains have a surfactant-type structure and comprise ion-exchange groups, wherein the ion-exchange material is obtainable by radical grafting of the side chains using a radical initiator containing at least one peroxide group, chosen from the group consisting of dibenzoyl peroxide; di-t-butyl peroxide; peroxosulfuric acid; peroxosulfate-based radical initiators; peroxodisulfuric acid; peroxodisulfate-based radical initiators.

32. The ion-exchange material as claimed in claim 31, wherein the side chain possesses a hydrophobic part having an aromatic structural unit.

33. The ion-exchange material as claimed in claim 32, wherein the ratio of the aromatic structural units present in the hydrophobic parts of the side chains to the number of the hydrophilic regions is ≧1.

34. The ion exchange material as claimed in claim 32, wherein the side chain comprises a structural unit which is selected from the group consisting of benzyl derivatives, naphthyl derivatives, biphenyl derivatives.

35. The ion-exchange material as claimed in claim 31, wherein the side chain possesses a hydrophobic part having an hydrocarbon chain of ≧6 carbon atoms.

36. The ion-exchange material as claimed in claim 31, wherein the support resin is formed of a polymer which possesses side chained unsaturated groups.

37. The ion-exchange material as claimed in claim 31, wherein the grafted side chains are themselves polymers.

38. The ion-exchange material as claimed in claim 31, wherein the support resin is particulate at median particle diameters in the range from 2 to 100 μm.

39. The ion-exchange material, in particular as claimed in claim 31, comprising a support resin having grafted side chains having cation-exchange groups, and anion-exchange material fixed to this support resin via ionic interactions, wherein the anion-exchange material is a polymer having cationic groups as a component of the main chain.

40. The ion-exchange material as claimed in claim 39, wherein the cationic groups, as a component of the main chain of the anion-exchange material are selected from the group consisting of quaternary ammonium groups, sulfonium groups, phosphonium groups, and mixtures thereof.

41. The ion-exchange material as claimed in claim 39, wherein the anion-exchange material comprises repeat units which are selected from the group consisting of: 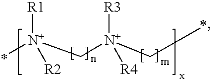
wherein independently of one another: n=2, 3, 4, 5, 6, 7, 8, 9, 10, 11, 12, 13, 14, 15, 16, 17, 18; m=2, 3, 4, 5, 6, 7, 8, 9, 10, 11, 12, 13, 14, 15, 16, 17, 18; R1=CH₃, C₂H₅; R2=CH₃, C₂H₅; R3=CH₃, C₂H₅; R4=CH₃, C₂H₅; and 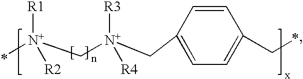
wherein independently of one another: n=2, 3, 4, 5, 6, 7, 8, 9, 10, 11, 12, 13, 14, 15, 16, 17, 18; R1=CH₃, C₂H₅; R2=CH₃, C₂H₅; R3=CH₃, C₂H₅; R4=CH₃, C₂H₅; and 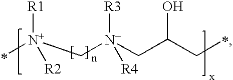
wherein independently of one another: n=2, 3, 4, 5, 6, 7, 8, 9, 10, 11, 12, 13, 14, 15, 16, 17, 18; R1=CH₃, C₂H₅; R2=CH₃, C₂H₅; R3=CH₃, C₂H₅; R4=CH₃, C₂H₅.

42. The ion-exchange material as claimed in claim 39, wherein the cation-exchange groups in the grafted side chains are selected from the group consisting of sulfonate groups, carboxyl groups, chelating agents and mixtures thereof.

43. The ion-exchange material as claimed in claim 39, wherein the cation-exchange capacity of the support resin having the grafted side chains is 1-250 μequiv/g.

44. The ion-exchange material as claimed in claim 31, wherein it is an anion-exchange material which possesses a signal asymmetry Aₛ for bromide and nitrate of ≦2 and/or with which the elution of fluoride does not occur with the dead volume.

45. A method for producing an ion-exchange material, in particular as claimed in claim 31, comprising the steps:
(a) providing a hydrophobic support resin;
(b) radical grafting of a grafting reagent having surfactant-type structure onto the support resin, wherein the grafting reagent comprises at least one ion-exchange group, using a radical initiator containing at least one peroxide group, dibenzoyl peroxide; di-t-butyl peroxide; peroxosulfuric acid; peroxosulfate-based radical initiators, peroxodisulfuric acid; peroxodisulfate-based radical initiators.

46. The method as claimed in claim 45, wherein the grafting reagent is purified before grafting onto the support resin.

47. The method as claimed in claim 45, wherein the grafting reagent possesses a hydrophobic part having an aromatic structural unit.

48. The method as claimed in claim 47, wherein the ratio of the aromatic structural units present in the hydrophobic parts of the grafting reagent to the number of hydrophilic regions is ≧1.

49. The method as claimed in claim 45, wherein the grafting reagent comprises a vinyl function, in particular a structural unit which is selected from the group consisting of vinylbenzyl derivatives; condensed vinylaromatics, non-condensed vinylpolyaromatics.

50. The method as claimed in claim 45, wherein the grafting reagent is selected from the group consisting of:
(a) vinylbenzyl derivatives according to the general formula: 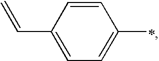
wherein (*) denotes an ion-exchange group bound directly or via a linker;
in particular 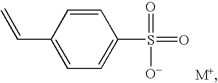
wherein M⁺ denotes an alkali cation, and/or 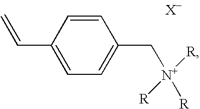
wherein X⁻ denotes a halide, and wherein (R) in each case independently of one another denotes a side chain;
(b) condensed vinylaromatics, according to the general formula 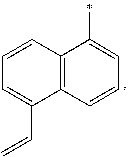
wherein (*) denotes an ion-exchange group bound directly or via a linker;
(c) non-condensed bi- or polyaromatics having at least one vinyl function and having at least one ion-exchange group, according to the general formula 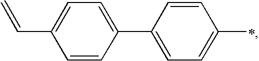
wherein (*) denotes an ion-exchange group bound directly or via a linker;
(d) di- or polyvinyl compounds, in each case bridged with a quaternary amine function,
according to the general formulae 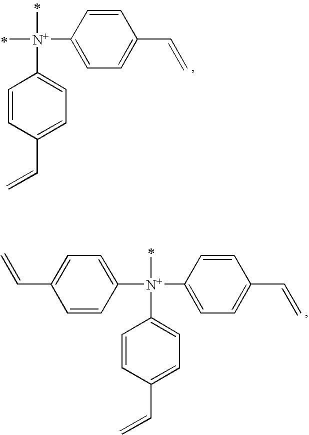
wherein (*) denotes an ion-exchange group bound directly or via a linker; or 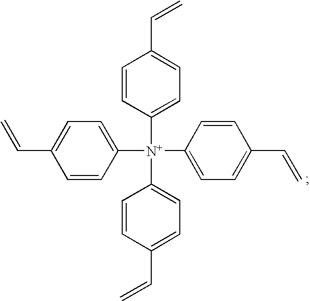
(e) di- or polyvinyl compounds, in each case bridged via more than one quaternary amine function,
according to the general formulae

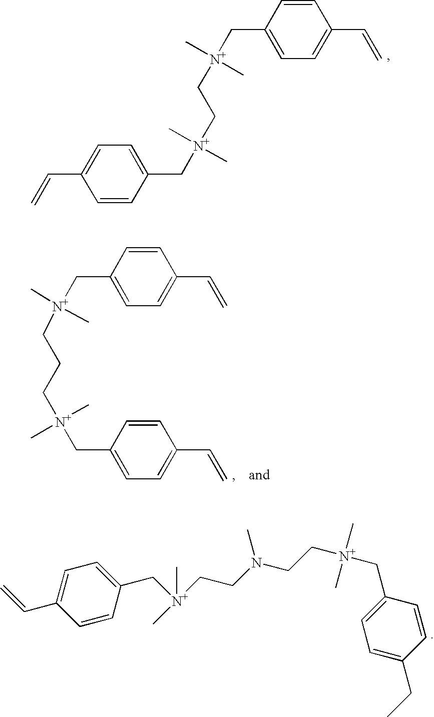

51. The method as claimed in claim 45, wherein the grafting reagent possesses a hydrophobic part having a car-on chain of ≧6 carbon atoms.

52. The method as claimed in claim 45, wherein the support resin comprises a polymer or consists of this which possesses side claimed unsaturated groups

53. The method as claimed in claim 45, characterized in that the grafting reaction is carried out as graft-block (co)polymerization or as graft-(co)polymerization.

54. The method in particular as claimed in claim 45, comprising the steps:
(a) functionalizing a hydrophobic support resin with cation-exchange groups by means of graft polymerization;
(b) fixing a polymeric anion-exchange material having cationic groups as a component of the main chain to the support resin via ionic interactions.

55. The method as claimed in claim 54, wherein the cationic groups comprise quaternary ammonium groups as component of the main chain of the anion-exchange material.

56. The method as claimed in claim 45, wherein the support resin is functionalized with at least one grafting reagent which contains at least one vinyl group and which further contains a functionality which is selected from the group consisting of sulfonate groups, carboxyl groups, chelating agents and mixtures thereof.

57. The method as claimed in claim 45, wherein the support resin is functionalized with at least one grafting reagent which contains at least one vinyl group and/or which contains at least one functionality which is selected from the group consisting of quaternary ammonium groups, sulfonium groups, phosphonium groups, arsonium groups and mixtures thereof.

58. The method as claimed in claim 45, wherein the graft polymerization is controlled in such a manner that an ion-exchange capacity of the functionalized support resin of 1-250 μequiv/g is achieved.

59. An ion-exchange column comprising an ion-exchange material as claimed in claim 31.

60. An ion-exchange column comprising an ion-exchange material obtainable by a method as claimed in claim 45.
